(19) United States
(12) Patent Application Publication
(10) Pub. No.: US 2004/0184465 A1
(43) Pub. Date: Sep. 23, 2004

(54) Mobile IP communication system using dual stack transition mechanism and method thereof

(75) Inventors: Sung-Jin Lee, Suwon-shi (KR); Jae-Hyuk Do, Yongin-shi (KR); Hyun-Jeong Kang, Seoul (KR); Sang-Won Min, Seoul (KR); Young-Jee Choi, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/804,659

(22) Filed: Mar. 19, 2004

(30) Foreign Application Priority Data
Mar. 19, 2003 (KR) 17259/2003

(51) Int. Cl. H04L 12/28; H04L 12/56

(52) U.S. Cl. 370/400; 370/338

(57) ABSTRACT

A system and method for assigning and managing a mobile IP in an access node for communicating with a mobile node supporting IP version 6 (IPv6) technology, assigning an IPv6 address to the mobile node, and using a dual stack transition mechanism capable of providing an IP version 4 (IPv4) address upon receiving an IPv4 address request from the mobile node, and a border router for interfacing between an IPv4 native network and an IPv6 native network.

### PRIORITY

This application claims priority under 35 U.S.C. § 119 to an application entitled “Mobile IP Communication System Using Dual Stack Transition Mechanism and Method Thereof” filed in the Korean Intellectual Property Office on Mar. 19, 2003 and assigned Serial No. 2003-17259, the contents of which are incorporated herein by reference.

### BACKGROUND OF THE INVENTION

1. Field of the Invention

The present invention relates generally to a communication system and method in an Internet Protocol. (IP) network, and in particular, to a communication system and method using a dual stack transition mechanism (DSTM).

2. Description of the Related Art

Generally, communication systems are classified as wired communication systems or wireless communication systems. Typically, the wired communication systems include a telephone communication system, an Integrated Services Digital Network (ISDN) communication network system, an optical communication system, an Internet communication system, etc. The wireless communication systems commonly include a cellular network-based communication system, a wireless local area network (LAN) system, a wireless local loop (WLL) system, etc. However, with the rapid progress of communication technology and the increased demands for improved communication services, there is a tendency to combine the wired communication systems with the wireless communication systems.

Accordingly, Internet technology has been developed to enable subscribers to access a particular server via a wired access network for data transmission and reception. An existing Internet protocol (IP), which was the fundamental Internet technology about 20 years ago, was designed based on IP version 4 (IPv4). Recently, however, due to the increasing number of Internet users, it is difficult to apply IPv4 Internet technology because of a lack of available IP addresses. Therefore, a Mobile IP used in a mobile network is evolving from the Mobile IP version 4 (Mobile IPv4) into a Mobile IP version 6 (Mobile IPv6), based on an IP version 6 (IPv6) that has been proposed as a next generation IP version.

As described above, because the Internet technology is a wire-based technology and is used all over the world, an enormous number of Internet nodes and networks are needed. However, all these Internet nodes have been designed and operated based on IPv4. Therefore, although IPv6 technology, which is the next generation Internet technology, is currently being commercialized, it will take quite a long time to replace the current Internet nodes supporting IPv4 (hereinafter referred to as “IPv4 Internet nodes”) with Internet nodes supporting IPv6 (hereinafter referred to as “IPv6 Internet nodes”).

In addition, although the IPv6 technology is available, it is expected that there will be many continuing demands for the current abundant IPv4-based applications and services. Therefore, various technologies for enabling an access from IPv6 Internet nodes to an IPv4 native network are being studied. Among many others, a dual stack transition mechanism (DSTM) is technology that is attracting a great deal of public attention.

FIG. 1 is a diagram illustrating a network configuration for a dual stack transition mechanism proposed in Internet Engineering Task Force (IETF). However, before a description of FIG. 1 is made, basic particulars will be described. Each Internet node should belong to an IPv6 Internet node or an IPv4 Internet node, and an IPv6 Internet node cannot directly communicate with an IPv4 Internet node. Therefore, for communication between an IPv6 Internet node and an IPv4 Internet node, a transition node is needed, and technology defined for this is a dual stack transition mechanism (DSTM).

Referring to FIG. 1, an IPv6 native network 110 is comprised of IPv6 Internet nodes (hereinafter referred to as “IPv6 nodes”), and an IPv4 native network 120 is comprised of IPv4 Internet nodes (hereinafter referred to as “IPv4 nodes”). A user node 113 searches respective nodes in the IPv6 native network 110 via a domain name service (DNS) server 111 and exchanges Internet data with the nodes according to the IPv6 technology. A user node 122 included in the IPv4 native network 120 accesses IPv4 nodes and exchanges Internet data with the IPv4 nodes. The user node 122 searches respective nodes included in the IPv4 native network 120 via a DNS server 121. An access node (supporting dynamic host configuration protocol version 6 (DHCPv6)) 112 based on the dual stack transition mechanism provides an IPv4 transition address to an IPv6 user node so that it can access an IPv4 node.

If the user node 113 sends an IPv4 address request to the access node 112 to access a particular IPv4 node, the access node 112 temporarily assigns an available IPv4 Internet address (IPv4 address) and provides the assigned IPv4 address to the user node 113. Then the user node 113 sends its own IPv6 Internet address and the IPv4 address assigned from the access node 112 to a border router (or tunnel end point (TEP)) 130. As a result, the user node 113 can access the IPv4 native network 120.

IPv6 Internet tunneling is performed between the user node 113 and the border router 130. Through the tunneling, data transmission between the user node 113 and the border router 130 is achieved. The border router 130 sends data received from the user node 113 to the IPv4 native network 120 using the temporarily assigned IPv4 address. A scheme for connecting an IPv6 native network to an IPv4 native network in this manner is called a dual stack transition mechanism.

However, in FIG. 1, the dual stack transition mechanism is considered for the IPv6 native network 110 and the IPv4 native network 120, both of which are fixed networks. That is, the dual stack transition mechanism is not considered for a Mobile IP but only for the fixed IPv6 native network 110 and IPv4 native network 120. Therefore, when a mobile node requiring a mobile IP, located in the IPv6 native network 110, is temporarily assigned an IPv4 address from the access node 112, the a number of problems occur.

A mobile node is assigned an IPv6 mobile IP when it is located in the IPv6 native network 110. Thereafter, when the mobile node desires to access the IPv4 native network 120, it sends an IPv4 address request to the access node 112 in order to be assigned an IPv4 address. In some cases, however, while communicating with the IPv4 native network 120 in this manner, the mobile node may move to another access node. If the mobile node moves to a new access node in this way, it is assigned a new IPv6 address from the new access node.

If the mobile node is assigned a new address, it informs the border router 130 of the newly assigned address so that tunneling between the mobile node and the border router 130 can be achieved using the newly assigned address. However, when tunneling information based on an existing address is updated (replaced) with tunneling information based on a new address, the IPv4 address temporarily assigned to the mobile node cannot be matched. That is, a discontinuation between a newly assigned IPv6 address and previously assigned IPv6 and IPv4 addresses occurs. Therefore, when a mobile node is assigned a new IPv6 address, continuous communication cannot be guaranteed.

Problems such as the above described are raised because the dual stack transition mechanism is designed without considering the mobility of nodes between the current IPv4 native network and the future IPv6 native network. Therefore, at this time, a Mobile IP, which is currently being studied and expected to be commercialized in the near future, cannot provide compatible services until the current IPv4 native networks are completely replaced with the new IPv6 native networks.

### SUMMARY OF THE INVENTION

It is, therefore, an object of the present invention to provide a system and method for supporting both a fixed node and a mobile node in an Internet communication system using a dual stack transition mechanism.

It is another object of the present invention to provide a system and method for securing seamless traffic transmission irrespective of a change in location of a node in an Internet communication system using a dual stack transition system.

According to a first aspect of the present invention, there is provided a system for providing mobility of a mobile node in a communication system including an access node for communicating with the mobile node supporting IP version 6 (IPv6) technology, assigning an IPv6 address to the mobile node, and using a dual stack transition mechanism capable of providing an IP version 4 (IPv4) address upon receiving an IPv4 address request from the mobile node, and a border router for interfacing between an IPv4 native network and an IPv6 native network, the system comprising: the access node for assigning an IPv6 address upon receiving an IPv6 address assignment request from the mobile node, assigning an IPv4 address to the mobile node upon receiving an IPv4 address assignment request, assigning a new IPv6 address upon receiving a location update request due to a change in access node, and defining an access node that assigned the IPv4 address as an access node of a home network and then performing location update on the mobile node if the mobile node assigned the new IPv6 address is assigned an IPv4 address; the border router for receiving an IPv6 address and an IPv4 address from the mobile node that desires to communicate with the IPv4 native network, storing the received IPv6 address and IPv4 address in an IP mapping table, performing communication with a node in the IPv4 native network requested by the mobile node, and updating a newly received IPv6 address into an address of the mobile node upon receiving an IPv6 address update request from the mobile node; and the mobile node for being assigned an IPv6 address and an IPv4 address from the access node, informing the border router of the received IPv6 address and IPv4 address to perform communication with an IP network, and when the access node is changed, being assigned a new IPv6 address from the changed access node and informing the border router of a previously assigned address and the newly assigned IPv6 address.

According to a second aspect of the present invention, there is provided a method for assigning and managing a mobile Internet protocol (IP) in an access node of a communication system including the access node which communicates with a mobile node supporting IP version 6 (IPv6) technology, assigns an IPv6 address to the mobile node and uses a dual stack transition mechanism capable of providing an IP version 4 (IPv4) address upon receiving an IPv4 address request from the mobile node, and a border router for interfacing between an IPv4 native network and an IPv6 native network, comprising the steps of: assigning a new mobile IP available in the access node upon receiving a new mobile IP assignment request from the mobile node which was assigned a mobile IP from another access node; and if the mobile node assigned a mobile IP from another access node is using an IPv4 address, defining a home network of the mobile node as an access node that assigned the IPv4 address, and sending an extension message to the access node defined as the home network of the mobile node each time an IPv4 address extension request signal is received from the mobile node.

According to a third aspect of the present invention, there is provided a method for interfacing packet data between an IP version 6 (IPv6) native network and an IP version 4 (IPv4) native network in a border router of a communication system including an access node which communicates with a mobile node supporting IPv6 technology, assigns an IPv6 address to the mobile node and uses a dual stack transition mechanism capable of providing an IPv4 address upon receiving an IPv4 address request from the mobile node, and the border router for interfacing between the IPv4 native network and the IPv6 native network, comprising the steps of: upon receiving an IPv6 address and an IPv4 address from the mobile node, storing the received IPv6 address and IPv4 address in an IP mapping table; interfacing a packet transmitted between the mobile node and a particular node in the IPv4 native network; and upon receiving a location update message of the mobile node, updating a previous IPv6 address from the IP mapping table into a new IPv6 address included in the location update message, and sending packet data received at the mobile node to the newly stored address.

According to a fourth aspect of the present invention, there is provided a method for communicating with an IP version 4 (IPv4) native network by a mobile node supporting IP version 6 (IPv6) technology in an IPv6 native network of a communication system including an access node which communicates with the mobile node, assigns an IPv6 address to the mobile node and uses a dual stack transition mechanism capable of providing an IPv4 address upon receiving an IPv4 address request from the mobile node, and a border router for interfacing between the IPv4 native network and the IPv6 native network, comprising the steps of: sending an IPv4 address request to the access node so as to be assigned an IPv4 address when communication with the IPv4 native network is necessary after being assigned the IPv6 address; informing the border router of the assigned IPv6 address and the IPv4 address, and thereafter, performing communication with a particular node in the IPv4 native network via the border router; if the access node from which the mobile node is assigned the IPv6 address is changed, sending a new IPv6 address request to the changed access node so as to be assigned an IPv6 address; and informing the border router of the previously assigned IPv6 address and the newly assigned IPv6 address and IPv4 address.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating a network configuration for a dual stack transition mechanism proposed in Internet Engineering Task Force (IETF);

FIG. 2 is a diagram illustrating a network configuration of an Internet communication system using a dual stack transition mechanism (DSTM) according to an embodiment of the present invention;

FIG. 3 is a flowchart illustrating a control procedure for supporting a Mobile IP by a border router according to an embodiment of the present invention;

FIG. 4 is a flowchart illustrating a control procedure for assigning and managing a mobile IP in an access node according to an embodiment of the present invention; and

FIG. 5 is a flowchart illustrating a control procedure of a mobile node in a communication system using a dual stack transition mechanism according to an embodiment of the present invention.

### DETAILED DESCRIPTION OF THE PREFERRED EMBODIMENT

Preferred embodiments of the present invention will now be described in detail herein below with reference to the annexed drawings. In the drawings, the same or similar elements are denoted by the same reference numerals even though they are depicted in different drawings. Additionally, in the following description, a detailed description of known functions and configurations incorporated herein has been omitted for conciseness.

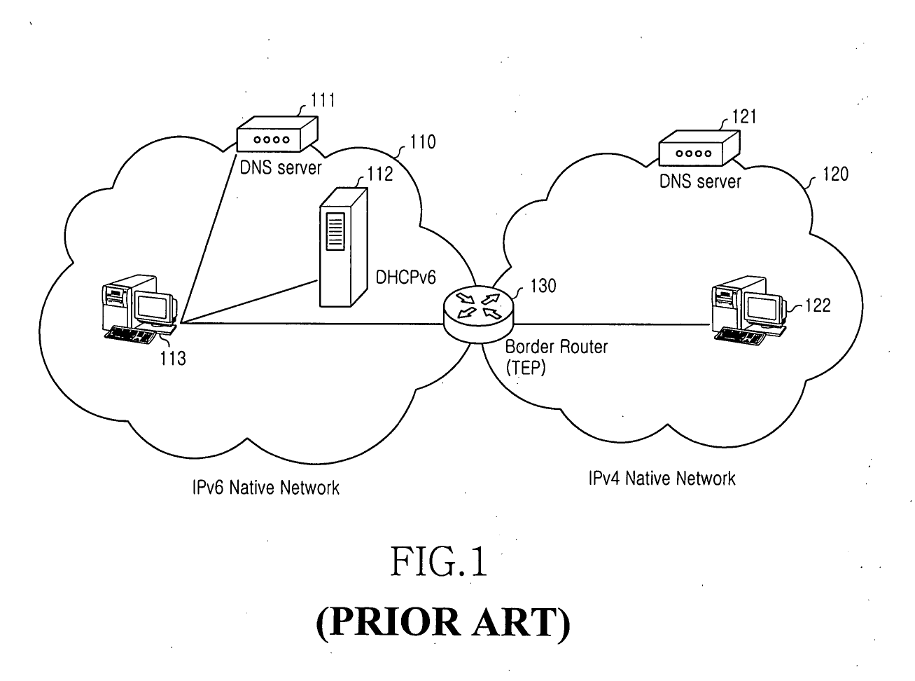

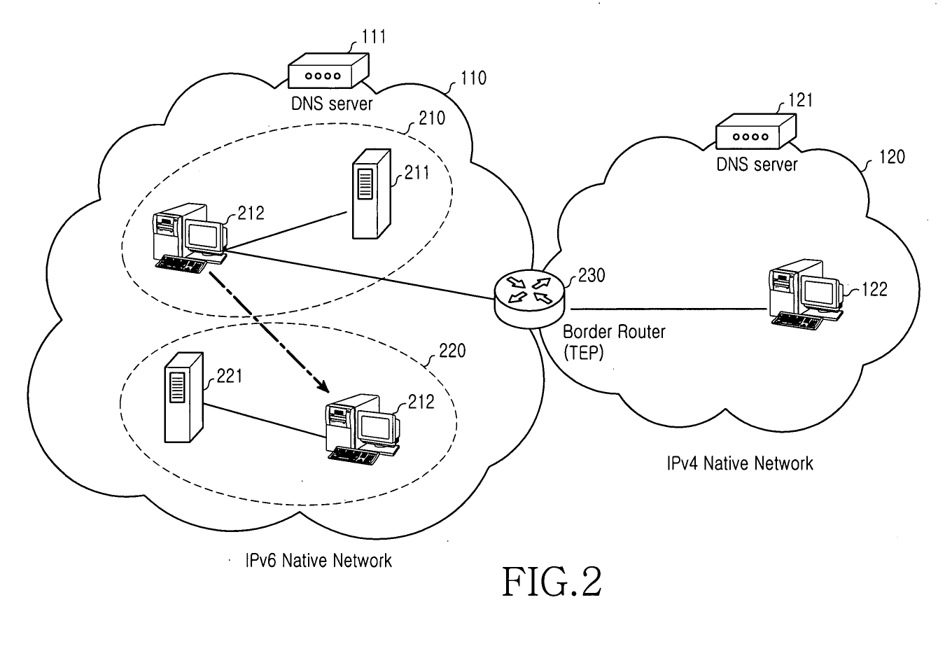

FIG. 2 is a diagram illustrating a network configuration of an Internet communication system using a dual stack transition mechanism (DSTM) according to an embodiment of the present invention. Referring to FIG. 2, a DNS server 111 of an IPv6 native network 110 is identical to that illustrated in FIG. 1 in structure and operation. A DNS server 121 and a user node 122 of an IPv4 native network 120 are also identical to those illustrated in FIG. 1. However, in this embodiment of the present invention, in order to explain the concept of a Mobile IP, two different access nodes 211 and 221 and two access networks 210 and 220 formed in association with the access nodes 211 and 221, respectively, are located within in the IPv6 native network 110. The access networks 210 and 220 independently control their own areas using their associated access nodes 211 and 221, and communicate with mobile nodes in the areas. Although a location of a mobile node changes, the mobile node can use the same Internet address. As described in the related art section, each of the access nodes 211 and 221 is a DSTM server and can be comprised of a DHCPv6 server.

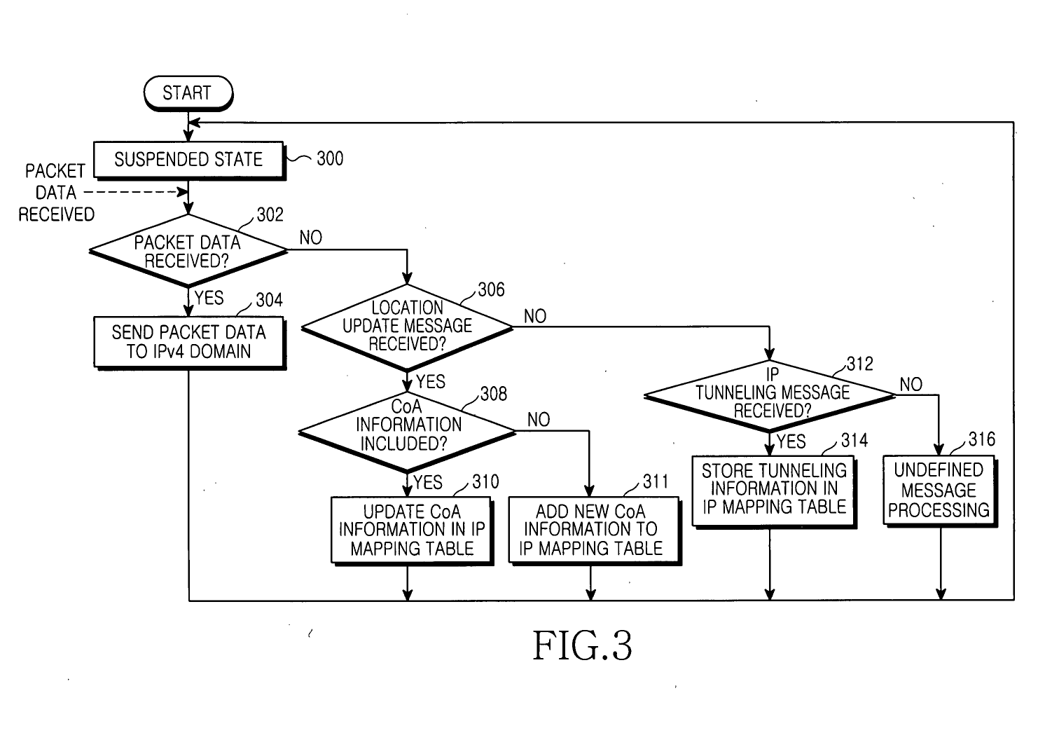

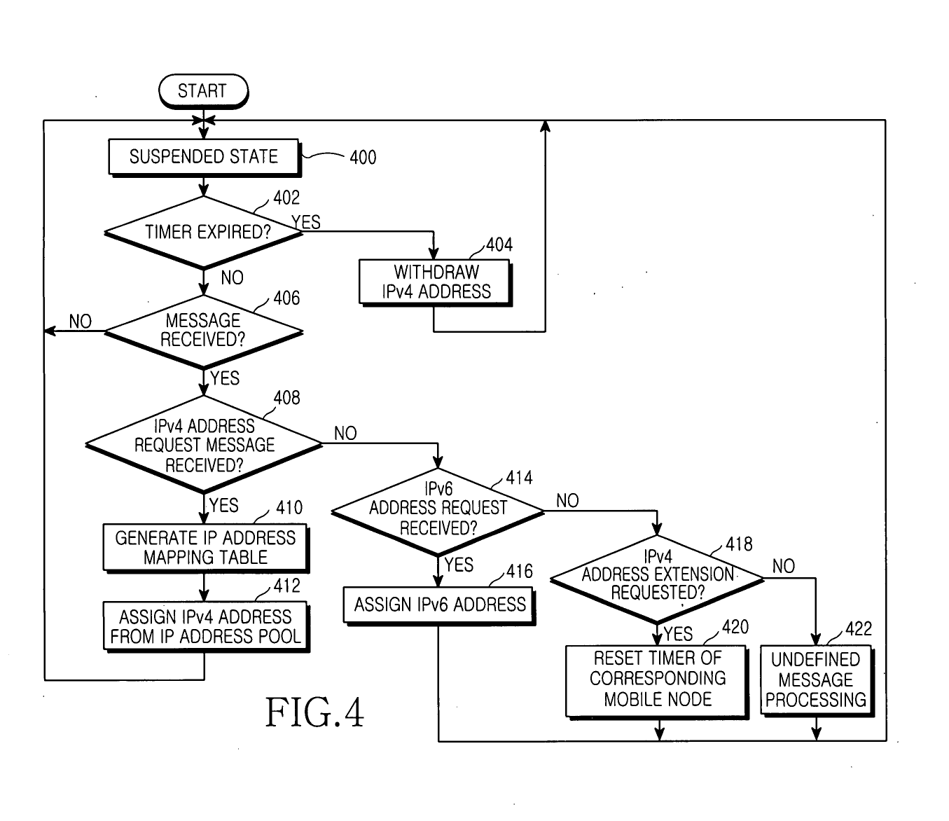

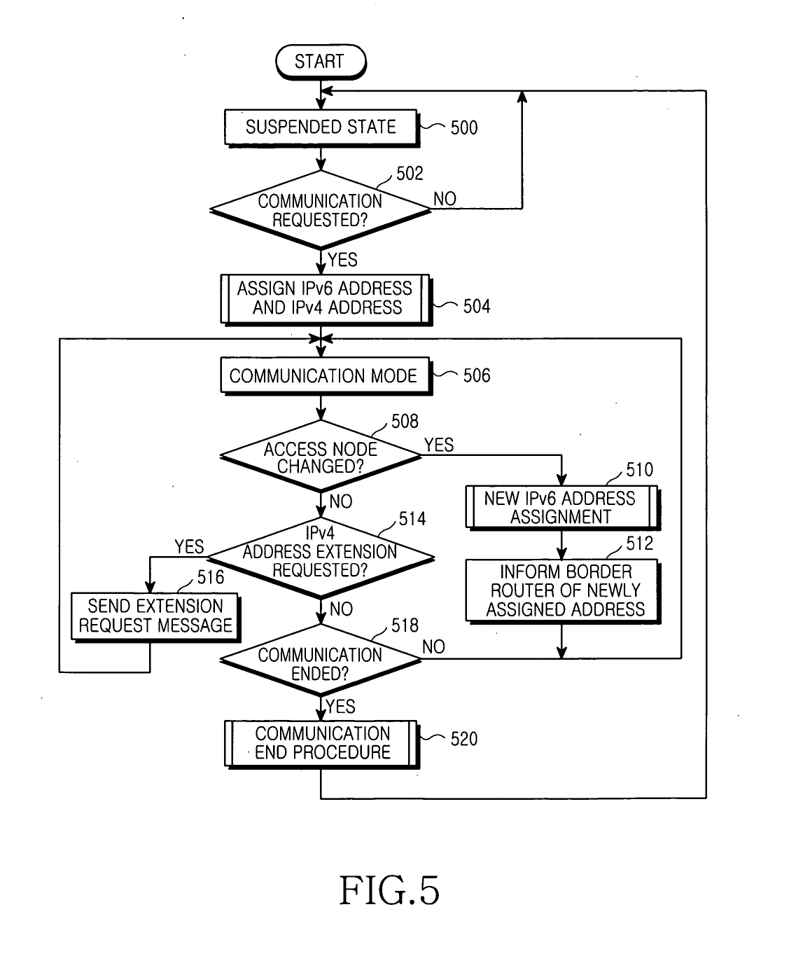

More specifically, the first access node 211 covers a first area 210 and performs Internet communication with IPv6 nodes. The first access node 211 assigns an IPv6 address available in the first area 210 upon receiving an IPv6 address request from a mobile node 212, which is capable of performing IPv6 communication. After being assigned an IPv6 address, if the mobile node 212 desires to access the IPv4 native network 120, the first access node 211 assigns a temporary IPv4 address to the mobile node 212. In FIG. 2, movement of the mobile node 212 is shown by a bold dot-dash line in order to describe a situation in which the mobile node 212 included in the first access node 211 moves to the second access network 220, which is an area of the second access node 221, after being assigned both an IPv6 address and an IPv4 address. That is, the mobile node 212 is the same mobile node and when an access node is changed, the mobile node 212 is newly assigned an IPv6 address from the second access node 221 of the second access network 220. When the mobile node 212 being assigned the IPv6 address and the IPv4 address from the first access node 211 moves to an area of the second access node 221, an operation is performed in accordance with a control procedure that will be described herein below with reference to FIGS. 4 and 5. In the following description, a network where the mobile node 212 has acquired an IPv6 mobile IP is defined as a home network, and a new network to which the mobile node 212 has moved is defined as a foreign network. In addition, a border router (TEP) 230 according to an embodiment of the present invention performs an operation in accordance with a control procedure that will be described herein below with reference to FIG. 3, and the other operations are identical to those described in connection with FIG. 1.

A detailed description will now be made herein below of an operation supporting a Mobile IP in the Internet communication system illustrated in FIG. 2.

When the mobile node 212 acquires an initial mobile IP from the first access node 211, the mobile node 212, as stated above, defines the first access node 211 as a home network and acquires an IPv6 address from the first access node 211. Thereafter, when the mobile node 212 desires to access the IPv4 native network 120, the mobile node 212 sends an IPv4 address request to the first access node 211. Then the first access node 211 generates an IP address mapping table, assigns an IPv4 address in an IP address pool prepared for assigning IPv4 addresses, and maps the assigned IPv4 address with the initially assigned IPv6 mobile IP. In addition, the first access node 211 drives a corresponding timer to manage the assigned IPv4 address.

After receiving the IPv6 address and the IPv4 address, the mobile node 212 can access any node in the IPv6 native network 110 and the IPv4 native network 120, and can communicate with the accessed node while it is located in the first access network 210. It will be assumed herein that such communication is performed with the IPv4 native network 120.

The mobile node 212 then sends the border router 230 its own mobile IP address (IPv6 address) and the IPv4 address assigned for IPv4 Internet communication. The border router 230 stores the IPv4 address and the IPv6 address in a mapping table for tunneling with the mobile node 212, and stores the tunneling information. As a result, the mobile node 212 can communicate with the IPv4 native network 120.

During communication, the mobile node 212 may move to the second access network 220. In this case, the mobile node 212 must be assigned a new IPv6 mobile IP from the second access node 221 of the second access network 220 to which the mobile node 212 has moved. Therefore, the mobile node 212 having entered the second access network 220 is assigned an IPv6 mobile IP from the second access node 221. Because the mobile node 212 recognizes an access node from which it is assigned an initial IPv6 mobile IP as a home network, the mobile node 212 provides an address of the home node 211 to the second access node 221. The second access node 221 then recognizes an address of the home network, which was received from the mobile node 212, as a home network address of the mobile node 212, and stores the address. Therefore, the second access node 221 performs a necessary signaling procedure between the node network and the mobile node 212, a location update, and registration operations on the home network.

The mobile node 212 is assigned a new IPv6 mobile IP address from the second access node 221, and sends the border router 230 the newly assigned IPv6 mobile IP address along with the IPv4 address assigned from the first access node 211 or a previously assigned IPv6 mobile IP address.

The border router 230 updates an address of an IPv6 node that was received from the first access node 211, using the newly received address. The address updating by the border router 230 is achieved by newly adding the newly assigned mobile IP address to the previously received information. In addition, it is possible to hold communication with the IPv4 native network 120 by writing the new address in a new tunneling table.

FIG. 3 is a flowchart illustrating a control procedure for supporting Mobile 1P by a border router according to an embodiment of the present invention. With reference to FIG. 3, a description will now be made of a control procedure performed in the border router 230 to support a Mobile IP according to an embodiment of the present invention.

Referring to FIG. 3, in step 300, the border router 230 holds a suspended state. Here, the “suspended state” refers to a state in which the border router 230 receives a specific signaling message, waits for an interrupt, or waits for packet data to be received. In the control procedure illustrated FIG. 3, it is assumed that packet data or a specific signaling message is received in the suspended state. If packet data is received in step 300, the border router 230 proceeds to step 302 where it determines whether a packet sent from a particular node in the IPv6 native network 110 to the IPv4 native network 120 has been received. If it is determined in step 302 that packet data transmitted to the IPv4 native network 120 has been received, the border router 230 proceeds to step 304. In step 304, the border router 230 sends the received packet data to an IPv4 domain, i.e., the IPv4 native network 120.

However, if it is determined in step 302 that packet data transmitted to the IPv4 native network 120 has not been received, the border router 320 proceeds to step 306. In step 306, the border router 230 determines whether a location update message has been received. Here, the “location update message” refers to new IPv6 mobile IP information received from the mobile node 212 due to a change in access node. If it is determined in step 306 that a location update message has been received, the border router 230 proceeds to step 308. In step 308, the border router 230 determines whether an address of a new access node is included in the existing mapping table, using information included in the received location update message. The determination can be achieved in several ways according to information received from the mobile node 212. First, a description will be made of a case where the mobile node 212 sends all of an IPv6 address and an IPv4 address of the home network and a newly assigned IPv6 address. In this case, the border router 230 determines whether a newly assigned IPv6 address is stored in the mapping table, using the IPv6 address assigned from the home network. Alternatively, if the mobile node 212 transmits the above-stated addresses, the border router 230 may search the mapping table using the assigned IPv4 address.

Next, a description will be made of methods for sending addresses in a different way by the mobile node 212. In a first method, the mobile node 212 transmits a newly assigned IPv6 address and an IPv4 address assigned for communication with the IPv4 native network. In a second method, the mobile node 212 transmits a newly assigned IPv6 address and an IPv6 address received from the home network. In this case, because the border router 230 must use previously stored information in searching the mapping table, the border router 230 performs the search using the IPv4 address in the first method, and performs the search using the IPv6 address received from the home network in the second method.

As a result of the search, if information on a new node, i.e., Care-of-Address (CoA), is included in the existing mapping table, the border router 230 proceeds to step 310. In step 310, the border router 230 updates CoA information received from a new access router in an IP mapping table.

However, if information on a new node is not included in the existing mapping table, i.e., when the mobile node 212 has moved for the first time, the border router 230 proceeds to step 311 where it adds new CoA information to the IP mapping table. Thereafter, the border router 230 returns to step 300. When the updating or addition is achieved in this way, the CoA information is stored in the IP mapping table used for sending packet data from the IPv4 native network 120 to the IPv6 native network 110, or from the IPv6 native network 110 to the IPv4 native network 120.

If it is determined in step 306 that a location update message has not been received, the border router 230 proceeds to step 312. In step 312, the border router 230 determines whether a message for IP tunneling is received from the IPv4 native network 120. The message received from the IPv4 native network 120 becomes a message for tunneling with a correspondent node (CN) that communicates with a particular node in the IPv6 native network 110. When the message is received, the border router 230 proceeds to step 314. In step 314, the border router 230 maps a particular node of the IPv4 native network 120 with a node of an IPv6 native network 110, stores the mapping result in the IP mapping table, stores information for tunneling between the border router 230 and a border router in a position to which the mobile node 212 has moved, in the IP mapping table, and then transitions to the suspended state in step 300.

When the message is not received in step 312, the border router 230 proceeds to step 316 where it considers that an undefined message is received, and then returns to the suspended state in step 300.

To summarize, in the control procedure illustrated in FIG. 3, the border router 230 considers only (i) when packet data transmitted to the IPv4 native network is received, (ii) when a location update message is received, and (iii) when a message for IP tunneling is received from the IPv4 native network. Therefore, when none of the messages corresponding to the determination results of the steps 302, 306 and 312 are received, the border router 230 proceeds to step 316 where it considers that an undefined message is received.

FIG. 4 is a flowchart illustrating a control procedure for assigning and managing a mobile IP in an access node according to an embodiment of the present invention. More specifically, referring to FIG. 4, a detailed description will now be made of a control procedure for assigning and managing a mobile IP by an access node in an IP network using a dual stack transition mechanism according to an embodiment of the present invention. It is assumed in FIG. 4 that an access node is the first access node 211 in the first access network 210.

Referring to FIG. 4, in step 400, the first access node 211 holds a suspended state. Here, the “suspended state” of the access node 211 refers to a state in which the first access node 211 waits for an interrupt for communication, an IPv6 mobile IP assignment request, or an IPv4 address assignment request, and monitors a timer for managing an assigned IP. In the suspended state of step 400, the first access node 211 proceeds to step 402 where it determines whether a timer expiration signal is received from any of IPv4 address timers. If it is determined in step 402 that a timer expiration signal is received, the first access node 211 proceeds to step 404. In step 404, the first access node 211 withdraws an IPv4 address assigned to a corresponding node whose timer has expired, and then returns to step 400.

However, if it is determined in step 402 that no IPv4 address management timer expiration event has occurred, the first access node 211 proceeds to step 406 where it determines whether a message has been received from a particular node or a mobile node. If it is determined in step 406 that a message has been received, the first access node 211 proceeds to step 408, and otherwise, the first access node 211 returns to step 400. In step 408, the first access node 211 determines whether an IPv4 address request message is received from a particular node. If it is determined in step 408 that an IPv4 address request message is received, the first access node 211 proceeds to step 410.

In step 410, the first access node 211 generates an IP address mapping table in order to map an IPv6 address previously assigned as a mobile IP for IPv4 assignment or an IPv6 address of a mobile node with an assigned IPv4 address. In step 412, the first access node 211 extracts an address from an IP address pool prepared for IPv4 address assignment and assigns the extracted address to a corresponding mobile node. Thereafter, the first access node 211 returns to step 400.

If it is determined in step 408 that an IPv4 address request message is not received, the first access node 211 proceeds to step 414. In step 414, the first access node 211 determines whether an IPv6 address request is received from a mobile node. That is, the first access node 211 determines in step 414 whether a mobile IP assignment request is received from a mobile node. If it is determined in step 414 that an IPv6 address request is received, the first access node 211 proceeds to step 416. In step 416, the first access node 211 assigns one of available mobile IPs as an IPv6 address. That is, a mobile node is assigned a temporary IPv6 address (or CoA) when it moves to a new network. In an alternative method, the mobile node can automatically generate an IPv6 address using prefix information received from a router in the new network. After the assignment process, the first access node 211 returns to step 400.

When the first access node 211 proceeds to step 418 because both the steps 408 and 414 are unsatisfied, the first access node 211 determines whether an IPv4 address extension request signal is received. The IPv4 address extension request signal can be received either directly from a user node or via another access node. If a user node having the IPv4 address is a mobile node and has moved its location, i.e., if the mobile node is located in another access node, the IPv4 address extension request signal is received from another access node. Although the user node is a fixed node, the fixed node, which is assigned an IPv4 address from the access node via a particular access node, can send an IPv4 address extension request signal via another node in this way.

If it is determined in step 418 that an IPv4 address extension request signal is received, the first access node 211 proceeds to step 420 where it resets a timer of a corresponding mobile node and then proceeds to step 400. However, if it is determined in step 418 that no IPv4 address extension request signal is received, the first access node 211 proceeds to step 422 where it regards the received message as an undefined message and then returns to step 400.

In the control procedure of FIG. 4, the first access node 211 considers only (i) when a message is received, (ii) when an IPv4 address request message is received, (iii) when an IPv6 address request is received, and (iv) when an IPv4 address extension request is received. Therefore, when none of the messages corresponding to the determination results of the steps 406, 408, 414 and 418 are received, the first access node 211 processes an undefined message.

FIG. 5 is a flowchart illustrating a control procedure of a mobile node in a communication system using a dual stack transition mechanism according to an embodiment of the present invention. More specifically, referring to FIG. 5, a detailed description will now be made of a control procedure of a mobile node in a communication system using a dual stack transition mechanism according to an embodiment of the present invention. It is assumed in FIG. 5 that a mobile node is the mobile node 212 included in the first access node 210 of FIG. 2.

Referring to FIG. 5, in step 500, the mobile node 212 holds a suspended state, and while holding the suspended state, the mobile node 212 determines whether communication with an 1P network is required in step 502. If it is determined in step 502 that communication with an IP network is required, the mobile node 212 proceeds to step 504 where it is assigned an IPv6 address, i.e., a mobile IP, and an IPv4 address. Actually, the mobile node 212 can be assigned an IPv6 mobile IP either during initial power-up or when necessary as illustrated in FIG. 5. It is assumed herein that the communication with an IP network requested in step 502 is communication with the IPv4 native network 120. A detailed description of the procedure for assigning the IPv4 address and the IPv6 address in step 504 will be omitted in order not to obscure the present invention.

In step 506, the mobile node 212 performs communication using the assigned IPv4 address and IPv6 address. That is, when communicating with the IPv4 native network 120, the mobile node 212 sends the IPv6 mobile IP and the IPv4 address assigned through the first access node 211 to the border router 230. In this manner, the border router 230 can perform tunneling of the IPv6 native network 110 as described in connection with FIG. 3.

When a tunneling message is received from the IPv4 native network 120, the mobile node 212 performs tunneling with a correspond node in the IPv4 native network 120. Performing communication with an IP network through such a procedure, the mobile node 212 determines in step 508 whether its access node has been changed. The change in access node can be detected based on a change in a mask IP address because the mask IP address the mobile node 212 performing Mobile IP communication receives from an access node is changed. When the access node is changed, the mobile node 212 proceeds to step 510 where it performs a new IPv6 address assignment procedure. This will be described herein below with reference to FIG. 2.

Referring to FIG. 2, if the mobile node 212 moves to the second access node 221 while communicating with the first access node 211, the mobile node 212 must be assigned a new IPv6 address. The mobile node 212 can detect the change in an access node by detecting a change in a prefix value received from an access node or detecting a change in a pilot signal. After detecting the change in an access node depending on a change in its location, the mobile node 212 performs a new IPv6 assignment procedure in step 510. Thereafter, in step 512, the mobile node 212 informs the border router 230 of the newly assigned address. The mobile node 212 transmits to the border router 230 the newly assigned IP address together with an IPv4 address assigned from the first access node 211 or an assigned IPv6 mobile IP address. Then the border router 230, as described in connection with FIG. 3, stores the new address and new mapping information in the IP mapping table to perform an update operation, making it possible to secure continuity of the communication.

However, if it is determined in step 508 that its access node is not changed, the mobile node 212 determines in step 514 whether extension of the IPv4 address is necessary. If it is determined in step 514 that extension of the IPv4 address is required, the mobile node 212 proceeds to step 516 where it generates an extension request message and sends the generated extension request message via an access node that the mobile node 212 is accessing. Whether extension of the IPv4 address is necessary is determined by driving a timer whose set time is shorter than that of a timer prepared in the access node. The mobile node 212 can send the message before an access node receiving the IPv4 address withdraws the IPv4 address. After transmitting the extension request message in step 516, the mobile node 212 returns to step 506 where it continuously communicates with the IP network.

If it is determined in step 514 that transmission of the IPv4 extension request message is not necessary, the mobile node 212 proceeds to step 518 where it determines whether communication with the IP network is ended. If it is determined in step 518 that the communication is ended, the mobile node 212 proceeds to step 520 where it performs a communication end procedure. Thereafter, the mobile node 212 returns to the suspended node in step 500. However, when the communication is not ended, the mobile node 212 proceeds to step 506 where it continues communication with the IP network.

As can be understood from the foregoing description, because each node changes its processing procedure by introducing the Mobile IP concept in the current dual stack transition mechanism technology, although Mobile IP is applied to a new IP network, communication can be seamlessly performed. In addition, both a fixed node and a mobile node are supported.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for assigning a mobile Internet protocol (IP) in an access node of a mobile communication system having the mobile IP, the method comprising the steps of:
assigning a first mobile IP (Mobile IPv6) address available in the access node upon receiving a request for assignment of the first mobile IP (Mobile IPv6) address from a mobile node;
assigning a second mobile IP (Mobile IPv4) address upon receiving a request for assignment of the second mobile IP address (Mobile IPv4) from a mobile node which was assigned the first mobile IP address; and
assigning a fifth mobile IP (Mobile IPv6) address when a mobile node that was assigned a third mobile IP (Mobile IPv6) address and a fourth mobile IP (Mobile IPv4) address has moved from another access node to the access node.

2. The method of claim 1, wherein the mobile node defines an access node that is initially assigned a Mobile IP address from the mobile communication system, as a home network.

3. The method of claim 1, further comprising the step of transmitting an extension message to the home network of the mobile node when the extension message for a Mobile IPv4 address is received from a mobile node, which has moved from the another access node.

4. The method of claim 1, further comprising the step of receiving an extension message for a Mobile IPv4 address from the another access node.

5. The method of claim 1, further comprising the step of, upon receiving a message requesting the second mobile IP (Mobile IPv4) address from the mobile node, extracting an available address from a second mobile IP (Mobile IPv4) pool and assigning the extracted address to the mobile node as the second mobile IP (Mobile IPv4) address.

6. The method of claim 5, wherein when assigning the second mobile IP (Mobile IPv4) address, the access node drives a timer for withdrawing the second mobile IP (Mobile IPv4) address and assigns the second mobile IP (Mobile IPv4) address to the mobile terminal until expiration of the timer.

7. The method of claim 5, further comprising the step of resetting a timer for withdrawing the second mobile IP (Mobile IPv4) address when an extension request signal for the second mobile IP (Mobile IPv4) address is received from the mobile node, which was assigned the second mobile IP (Mobile IPv4) address from the access node.

8. An apparatus for assigning a mobile Internet protocol (IP) in an access node of a mobile communication system having the mobile IP, the apparatus comprising:
means for assigning a first mobile IP (Mobile IPv6) address available in the access node upon receiving a request for assignment of the first mobile IP (Mobile IPv6) address from a mobile node;
means for assigning a second mobile IP (Mobile IPv4) address upon receiving a request for assignment of the second mobile IP address (Mobile IPv4) from a mobile node which was assigned the first mobile IP address; and
means for assigning a fifth mobile IP (Mobile IPv6) address when a mobile node that was assigned a third mobile IP (Mobile IPv6) address and a fourth mobile IP (Mobile IPv4) address has moved from another access node to the access node.

9. The apparatus of claim 8, wherein the mobile node defines an access node that is initially assigned a Mobile IP address from the mobile communication system, as a home network.

10. The apparatus of claim 8, further comprising means for transmitting an extension message to the home network of the mobile node when the extension message for a Mobile IPv4 address is received from a mobile node, which has moved from said another access node.

11. The apparatus of claim 8, further comprising means for receiving an extension message for a Mobile IPv4 address from the another access node.

12. The apparatus of claim 8, further comprising means for, upon receiving a message requesting the second mobile IP (Mobile IPv4) address from the mobile node, extracting an available address from a second mobile IP (Mobile IPv4) pool and assigning the extracted address to the mobile node as the second mobile IP (Mobile IPv4) address.

13. The apparatus of claim 12, wherein when assigning the second mobile IP (Mobile IPv4) address, the access node drives a timer for withdrawing the second mobile IP (Mobile IPv4) address and assigns the second mobile IP (Mobile IPv4) address to the mobile terminal until expiration of the timer.

14. The apparatus of claim 12, further comprising means for resetting a timer for withdrawing the second mobile IP (Mobile IPv4) address when an extension request signal for the second mobile IP (Mobile IPv4) address is received from the mobile node, which was assigned the second mobile IP (Mobile IPv4) address from the access node.

15. A method for transmitting data between a first mobile communication network and a second mobile communication network in a border router of a mobile communication system utilizing a mobile Internet protocol (IP), the method comprising the steps of:
receiving a first mobile IP (Mobile IPv6) address and a second mobile IP (Mobile IPv4) address from a mobile node;
storing the received first mobile IP (Mobile IPv6) address and second mobile IP (Mobile IPv4) address;
updating a third mobile IP being one of (Mobile IPv6) and (Mobile IPv4) address included in a location update message when the location update message is received from the mobile node; and
transmitting a packet using the stored mobile IP addresses when packet data transmitted from a mobile node belonging to the first mobile communication network to the second mobile communication network is received.

16. The method of claim 15, wherein the first mobile communication network performs communication using the first mobile IP (Mobile IPv6) address.

17. The method of claim 15, wherein the second mobile communication network performs communication using the second mobile IP (Mobile IPv4) address.

18. The method of claim 15, further comprising the steps of:
storing tunneling information in an IP mapping table upon receiving the tunneling information from each mobile node; and
transmitting packet data by tunneling based on the tunneling information.

19. An apparatus for transmitting data between a first mobile communication network and a second mobile communication network in a border router of a mobile communication system utilizing a mobile Internet protocol (IP), the apparatus comprising:
means for receiving a first mobile IP (Mobile IPv6) address and a second mobile IP (Mobile IPv4) address from a mobile node;
means for storing the received first mobile IP (Mobile IPv6) address and second mobile IP (Mobile IPv4) address;
means for updating a third mobile IP being one of (Mobile IPv6) and (Mobile IPv4) address included in a location update message when the location update message is received from the mobile node; and
means for transmitting a packet using the stored mobile IP addresses when packet data transmitted from a mobile node belonging to the first mobile communication network to the second mobile communication network is received.

20. The apparatus of claim 19, wherein the first mobile communication network performs communication using the first mobile IP (Mobile IPv6) address.

21. The apparatus of claim 19, wherein the second mobile communication network performs communication using the second mobile IP (Mobile IPv4) address.

22. The apparatus of claim 19, further comprising:
means for storing tunneling information in an IP mapping table upon receiving the tunneling information from each mobile node; and
means for transmitting packet data by tunneling based on the tunneling information.

23. A method for transmitting/receiving data between a first mobile communication network and a second mobile communication network in a mobile node of a mobile communication system utilizing a mobile Internet protocol (IP), the method comprising the steps of:
receiving a first mobile 1P (Mobile IPv6) address assigned from the first mobile communication network;
receiving a second mobile IP (Mobile IPv4) address assigned by sending a request for the second mobile IP (Mobile IPv4) address to an access node when communication with the second mobile communication network is required;
transmitting the assigned first mobile IP (Mobile IPv6) address and second mobile IP (Mobile IPv4) address to a border router; and
receiving and assigning a third mobile IP (Mobile IPv6) address, and transmitting the assigned third mobile IP address to the border router when the mobile node moves to another access node in the first mobile communication network.

24. The method of claim 23, further comprising the step of transmitting data to the border router when the mobile node desires to transmit packet data to the second mobile communication network.

25. The method of claim 23, further comprising the steps of:
determining whether the mobile node was assigned the third mobile IP (Mobile IPv6) address, when one of the assigned second mobile IP (Mobile IPv4) address and a fourth mobile IP (Mobile IPv4) address is extended; and
generating extension information of the second mobile IP (Mobile IPv4) address if it is determined that the mobile node is not assigned the third mobile IP (Mobile IPv6) address, and generating extension information of the second mobile IP (Mobile IPv4) address, including information on a network from which the mobile node is assigned the first mobile IP (Mobile IPv6) address, information on the second mobile IP (Mobile IPv4) address and information on third mobile IP (Mobile IPv6) address, if it is determined that the mobile node is assigned the third mobile IP (Mobile IPv6) address is assigned.

26. The method of claim 23, further comprising the step of transmitting the third mobile IP (Mobile IPv6) address and one of the first mobile IP (Mobile IPv6) address and the second mobile IP (Mobile IPv4) address to the border router, when the third mobile IP (Mobile IPv6) address is received from the access node.

27. An apparatus for transmitting/receiving data between a first mobile communication network and a second mobile communication network in a mobile node of a mobile communication system utilizing a mobile Internet protocol (IP), the apparatus comprising:
means for receiving a first mobile IP (Mobile IPv6) address assigned from the first mobile communication network;
means for receiving a second mobile IP (Mobile IPv4) address assigned by sending a request for the second mobile IP (Mobile IPv4) address to an access node when communication with the second mobile communication network is required;
means for transmitting the assigned first mobile IP (Mobile IPv6) address and second mobile IP (Mobile IPv4) address to a border router; and
means for receiving and assigning a third mobile IP (Mobile IPv6) address and transmitting the assigned third mobile IP address to the border router, when the mobile node moves to another access node in the first mobile communication network.

28. The apparatus of claim 27, further comprising means for transmitting data to the border router when the mobile node desires to transmit packet data to the second mobile communication network.

29. The apparatus of claim 27, further comprising:
means for determining whether the mobile node was assigned the third mobile IP (Mobile IPv6) address, when one of the assigned second mobile IP (Mobile IPv4) address and a fourth mobile IP (Mobile IPv4) address is extended; and
means for generating extension information of the second mobile IP (Mobile IPv4) address if it is determined that the mobile node is not assigned the third mobile IP (Mobile IPv6) address, and generating extension information of the second mobile IP (Mobile IPv4) address, including information on a network from which the mobile node is assigned the first mobile IP (Mobile IPv6) address, information on the second mobile IP (Mobile IPv4) address and information on third mobile IP (Mobile IPv6) address, if it is determined that the mobile node is assigned the third mobile IP (Mobile IPv6) address is assigned.

30. The apparatus of claim 27, further comprising means for transmitting the third mobile IP (Mobile IPv6) address and one of the first mobile IP (Mobile IPv6) address and the second mobile IP (Mobile IPv4) address to the border router, when the third mobile IP (Mobile IPv6) address is received from the access node.
